(19) United States
(12) Patent Application Publication
(10) Pub. No.: US 2026/0036062 A1
(43) Pub. Date: Feb. 5, 2026

(54) Control Device, Moving Object, and Control Method

(71) Applicant: HONDA MOTOR CO., LTD., Tokyo (JP)

(72) Inventor: Hisao HAGA, Wako-shi, Saitama-ken (JP)

(21) Appl. No.: 18/732,861

(22) Filed: Jun. 4, 2024

(30) Foreign Application Priority Data
Jun. 5, 2023 (JP) 2023-092358

(51) Int. Cl. F02C 9/28; F01D 15/10

(52) U.S. Cl. CPC F02C 9/28; F01D 15/10; F05D 2220/764; F05D 2270/02; F05D 2270/304

(57) ABSTRACT

A control device includes a first rotational speed acquisition unit (acquisition unit) that acquires a first rotational speed, which is the rotational speed of a gas turbine engine, based on a signal supplied from a rotational speed sensor, a second rotational speed acquisition unit (acquisition unit) that acquires a second rotational speed, which is the rotational speed of a power generator, based on a signal supplied from a rotation angle sensor, a comparison unit that compares the first rotational speed with the second rotational speed, and a control unit that controls the gas turbine engine and the power generator based on the lower one of the first rotational speed and the second rotational speed based on a comparison result by the comparison unit.

### CROSS-REFERENCE TO RELATED APPLICATIONS

This application is based upon and claims the benefit of priority from Japanese Patent Application No. 2023-092358 filed on Jun. 5, 2023, the contents of which are incorporated herein by reference.

### BACKGROUND OF THE INVENTION

### FIELD OF THE INVENTION

The present invention relates to a control device, a moving object, and a control method.

### DESCRIPTION OF THE RELATED ART

In recent years, research and development have been conducted on electrification technologies that contribute to energy efficiency in order to ensure access of more people to affordable, reliable, sustainable, and modern energy.

JP H01-219322 A discloses a gas turbine generator including a gas turbine engine provided with a compressor and a generator driven by the gas turbine engine. In the technique disclosed in JP H01-219322 A, when the pressure of the compressor exceeds a reference value and the rotational speed of the generator exceeds a reference value, supply of the fuel to the gas turbine engine is stopped. Thus, the technique of JP H01-219322 A prevents the gas turbine generator from overrunning.

### SUMMARY OF THE INVENTION

It is desired to provide a control device, a control method, and a moving object equipped with the control device, which are capable of controlling a power generation system including a gas turbine engine and a power generator in a more favorable manner.

An object of the present invention is to solve the above-described problem.

According to the present invention, there is provided a control device including: a first rotational speed acquisition unit configured to acquire a first rotational speed, which is a rotational speed of a gas turbine engine, based on a signal supplied from a rotational speed sensor provided in the gas turbine engine; a second rotational speed acquisition unit configured to acquire a second rotational speed, which is a rotational speed of a power generator, based on a signal supplied from a rotation angle sensor provided in the power generator, the power generator being rotated by the gas turbine engine; a comparison unit configured to compare the first rotational speed with the second rotational speed; and a control unit configured to control the gas turbine engine and the power generator based on a lower one of the first rotational speed and the second rotational speed based on a comparison result by the comparison unit.

According to the present invention, there is provided a moving object including the above control device.

According to the present invention, there is provided a control method including: acquiring a first rotational speed, which is a rotational speed of a gas turbine engine, based on a signal supplied from a rotational speed sensor provided in the gas turbine engine; acquiring a second rotational speed, which is a rotational speed of a power generator, based on a signal supplied from a rotation angle sensor provided in the power generator, the power generator being rotated by the gas turbine engine; comparing the first rotational speed with the second rotational speed; and controlling the gas turbine engine and the power generator based on a lower one of the first rotational speed and the second rotational speed based on a result of comparison between the first rotational speed and the second rotational speed.

According to the present invention, it is possible to provide a control device, a control method, and a moving object including the control device, which can control a power generation system more favorably.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of a moving object;

FIG. 2 is a schematic diagram of a power generation system;

FIG. 3 is a functional block diagram of each ECU;

FIG. 4 is a flowchart of a processing performed by the management ECU;

FIG. 5 is a block diagram of a processing performed by the setting unit;

FIG. 6 is a flowchart of a processing performed by the engine ECU;

FIG. 7 is a flowchart of a processing performed by the power generator ECU;

FIG. 8 is a diagram showing a relationship between the rotational speed and the torque of the power generation device;

FIG. 9 is a diagram showing a relationship between the rotational speed and the torque of the power generation device; and

FIG. 10 is a diagram showing a relationship between the rotational speed and the torque of the power generation device.

### DETAILED DESCRIPTION OF THE INVENTION

### Moving Object 10

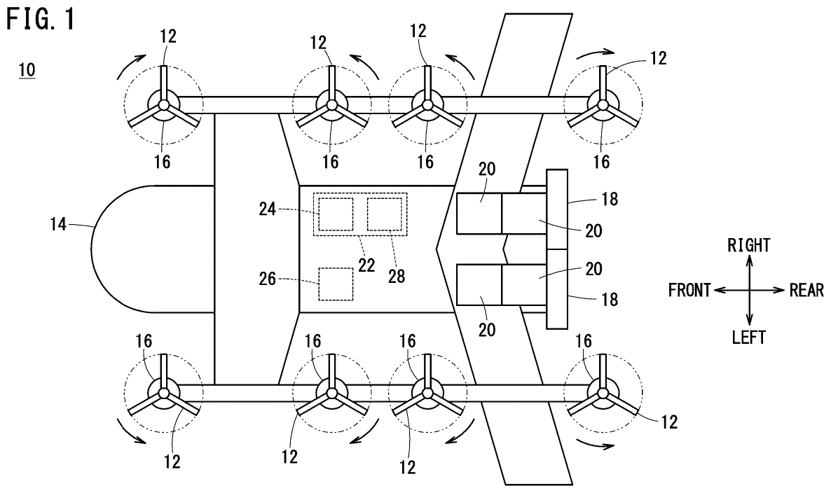

FIG. 1 is a schematic view of a moving object 10. The moving object 10 includes an electric load. The moving object 10 according to the following embodiment is an electric vertical take-off and landing aircraft (eVTOL aircraft). The moving object 10 may be an aircraft other than the eVTOL aircraft. The moving object 10 is not limited to an aircraft, and may be a ship, an automobile, a train, or the like.

The moving object 10 includes eight VTOL rotors 12. The VTOL rotor 12 generates an upward thrust on a fuselage 14. The moving object 10 includes eight electric motors 16. The electric motor 16 is the electric load. One electric motor 16 drives one VTOL rotor 12.

The moving object 10 includes two cruise rotors 18. The cruise rotor 18 generates a forward thrust on the fuselage 14. The moving object 10 includes four electric motors 20. The electric motor 20 is the electric load. Two electric motors 20 drive one cruise rotor 18.

The moving object 10 includes a power generation system 22 including a power generation device 24. The moving object 10 includes a power storage device 26. The power storage device 26 can store a part of electric power generated by the power generation device 24. The power generation device 24 and the power storage device 26 can supply electric power to each electric load.

### Power Generation System 22

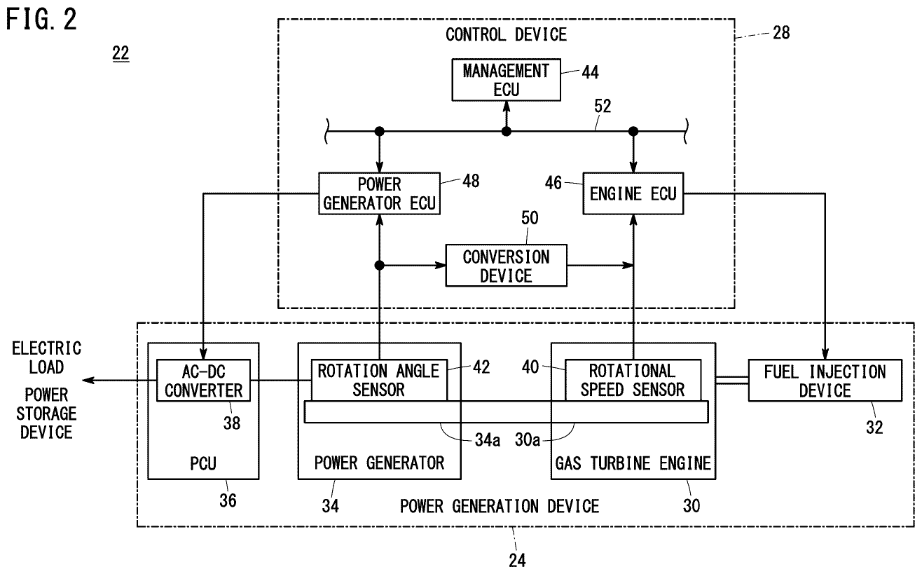

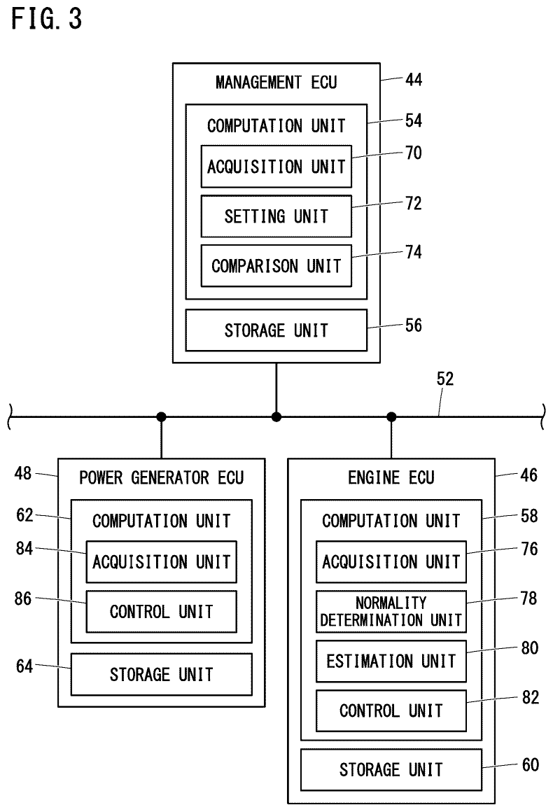

FIG. 2 is a schematic diagram of a power generation system 22. FIG. 3 is a functional block diagram of each ECU. The power generation system 22 operates to generate electric power requested by a controller (not shown) of the moving object 10. The power generation system 22 includes a power generation device 24 and a control device 28. Note that, here, a case where the power generation system 22 is provided in the moving object 10 will be described as an example, but the present invention is not limited thereto. The power generation system 22 may be provided in facilities, a factory, or the like.

The power generation device 24 includes a gas turbine engine 30, a fuel injection device 32, a power generator 34, and a power control unit (PCU) 36. A rotation shaft 30a of the gas turbine engine 30 and a rotation shaft 34a of the power generator 34 are connected to each other. The gas turbine engine 30 rotates the power generator 34. The fuel injection device 32 includes an injector (not shown). The injector operates in response to an operation signal transmitted from the control device 28, to thereby supply fuel to a combustor of the gas turbine engine 30. The power generator 34 is rotated by the gas turbine engine 30 to generate three-phase alternating current (AC) power. The PCU 36 converts the three-phase AC power generated by the power generator 34 into direct current (DC) power. The PCU 36 includes an AC-DC converter 38. The AC-DC converter 38 includes a plurality of switching elements (not shown). The switching element operates in response to an operation signal transmitted from the control device 28, to thereby control the DC power supplied to the power storage device 26 and the electric load.

The power generation device 24 includes a rotational speed sensor 40 and a rotation angle sensor 42. The rotational speed sensor 40 is disposed in the vicinity of the rotation shaft 30a of the gas turbine engine 30. The rotation angle sensor 42 is disposed in the vicinity of the rotation shaft 34a of the power generator 34.

The rotational speed sensor 40 detects the rotational speed of the gas turbine engine 30. The rotational speed sensor 40 transmits a digital signal indicating the rotational speed of the gas turbine engine 30 to the control device 28. For example, an electromagnetic pickup is used as the rotational speed sensor 40. In the present specification, the rotational speed of the gas turbine engine 30 is also referred to as an ENG rotational speed (first rotational speed). “ENG” is an abbreviation for “engine”.

The rotation angle sensor 42 detects the rotation angle of the power generator 34. The rotation angle sensor 42 transmits an analog signal indicating the rotation angle of the power generator 34 to the control device 28. For example, a resolver is used as the rotation angle sensor 42. The rotation angle detected by the rotation angle sensor 42 is converted into the rotational speed by the control device 28. In the present specification, the rotational speed of the power generator 34 is also referred to as a GEN rotational speed (second rotational speed). “GEN” is an abbreviation for “generator”.

The rotation shaft 30a of the gas turbine engine 30 is connected to the rotation shaft 34a of the power generator 34 without a gear or the like. Therefore, the actual rotational speed of the gas turbine engine 30 and the actual rotational speed of the power generator 34 are the same. On the other hand, the ENG rotational speed detected by the rotational speed sensor 40 and the GEN rotational speed calculated from the rotation angle detected by the rotation angle sensor 42 may differ from each other due to a failure of the sensors, noise, or the like.

The control device 28 includes a management electronic control unit (ECU) 44, an engine ECU 46, a power generator ECU 48, and a conversion device 50.

Each of the management ECU 44, the power generator ECU 48, and the engine ECU 46 is connected to a CAN bus 52. The management ECU 44, the power generator ECU 48, and the engine ECU 46 can communicate with each other via the CAN bus 52.

As shown in FIG. 3, each ECU includes a computation unit and a storage unit. That is, the management ECU 44 includes a computation unit 54 and a storage unit 56. The engine ECU 46 includes a computation unit 58 and a storage unit 60. The power generator ECU 48 includes a computation unit 62 and a storage unit 64.

The computation units 54, 58, and 62 are processors such as a central processing unit (CPU), a graphics processing unit (GPU), or the like. The computation units 54, 58, and 62 control the devices by executing the programs stored in the storage units 56, 60, and 64. At least a part of the computation units 54, 58, and 62 may be realized by an integrated circuit such as an ASIC (Application Specific Integrated Circuit), an FPGA (Field-Programmable Gate Array), or the like. At least a part of the computation units 54, 58, and 62 may be realized by an electronic circuit including a discrete device.

The storage units 56, 60, and 64 are configured by a volatile memory (not illustrated) and a nonvolatile memory (not illustrated) which are computer-readable storage medium. The volatile memory is, for example, a random access memory (RAM). The nonvolatile memory is, for example, a read only memory (ROM), a flash memory, or the like. Data and the like are stored in, for example, the volatile memory. The program, the table, the map, and the like are stored in, for example, the nonvolatile memory. At least a part of the storage units 56, 60, and 64 may be included in the above-described processor, integrated circuit, or the like.

The computation unit 54 provided in the management ECU 44 functions as an acquisition unit 70, a setting unit 72, and a comparison unit 74. The acquisition unit 70 acquires various kinds of information from the outside of the computation unit 54 or acquires various kinds of information by calculation or the like. The setting unit 72 sets an operation point. The operation point is a control target value of the power generation device 24. Information indicating the operation point includes a target rotational speed of the gas turbine engine 30 and a target torque value of the power generator 34. The comparison unit 74 compares the ENG rotational speed recognized by the engine ECU 46 with the GEN rotational speed recognized by the power generator ECU 48.

The computation unit 58 provided in the engine ECU 46 functions as an acquisition unit 76 (first rotational speed acquisition unit), a normality determination unit 78, an estimation unit 80, and a control unit 82. The acquisition unit 76 acquires various kinds of information from the outside of the computation unit 58 or acquires various kinds of information by calculation or the like. The normality determination unit 78 determines whether the rotational speed sensor 40 and the conversion device 50 are normal or abnormal. The estimation unit 80 estimates the ENG rotational speed based on the rotation angle detected by the rotation angle sensor 42 when an abnormality occurs in the rotational speed sensor 40. The control unit 82 controls the operation of the gas turbine engine 30 in a manner so that the rotational speed of the gas turbine engine 30 becomes the target rotational speed. Specifically, the control unit 82 controls the fuel injection device 32 to adjust the amount of fuel supplied to the gas turbine engine 30.

The computation unit 62 provided in the power generator ECU 48 functions as an acquisition unit 84 (second rotational speed acquisition unit) and a control unit 86. The acquisition unit 84 acquires various kinds of information from the outside of the computation unit 62 or acquires various kinds of information by calculation or the like. The control unit 86 controls the operation of the power generator 34 in a manner so that the torque value of the power generator 34 becomes the target torque value. Specifically, the control unit 86 controls the AC-DC converter 38 to adjust the generated current of the power generator 34.

As shown in FIG. 2, the conversion device 50 converts an analog signal transmitted from the rotation angle sensor 42 into a digital signal. When the rotation angle sensor 42 is a resolver, an RD (resolver/digital) converter is used as the conversion device 50. The conversion device 50 transmits the converted digital signal to the engine ECU 46.

### Processing to be performed by Management ECU 44

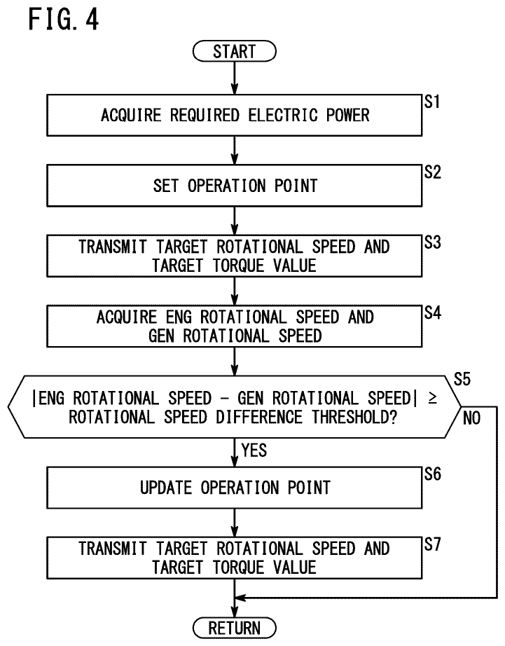

FIG. 4 is a flowchart of processing performed by the management ECU 44. The management ECU 44 performs processing related to management of the power generation device 24. The management ECU 44 repeatedly executes a series of steps shown in FIG. 4 while the power of the moving object 10 is in an ON state.

In step S1, the acquisition unit 70 provided in the management ECU 44 acquires the electric power required from the controller of the moving object 10. This electric power is referred to as a required electric power. The controller of the moving object 10 calculates the required electric power based on the operation state of the electric device provided in the moving object 10, the flight state of the moving object 10, the operation of the operator, and the like. The controller of the moving object 10 transmits the calculated required electric power to the management ECU 44. The acquisition unit 70 acquires this required electric power.

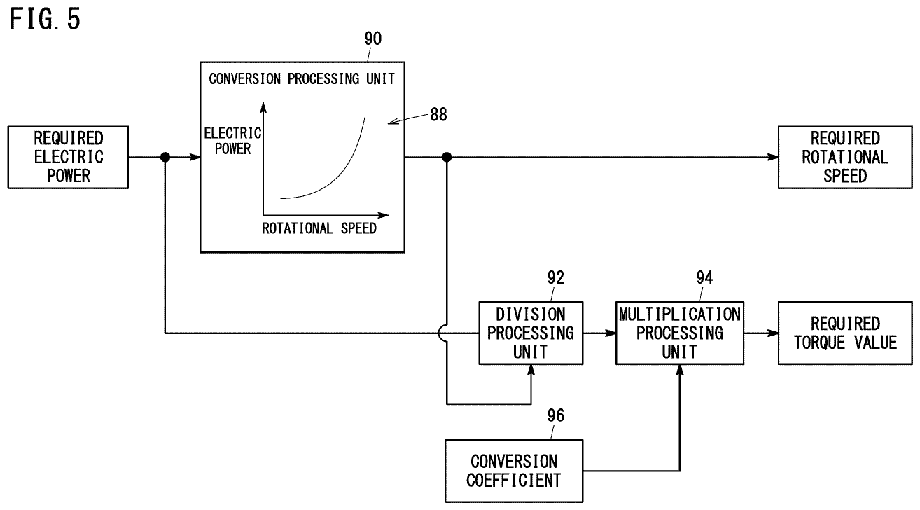

In step S2, the setting unit 72 provided in the management ECU 44 sets the operation point based on the required electric power. The setting unit 72 can set the operation point by acquiring the required rotational speed and the required torque value by performing the process shown in FIG. 5, for example. The setting unit 72 includes a conversion processing unit 90, a division processing unit 92, and a multiplication processing unit 94. The conversion processing unit 90 converts the required electric power into the required rotational speed using a map 88. The division processing unit 92 divides the required rotational speed acquired by the conversion processing unit 90 by the required electric power. The multiplication processing unit 94 calculates the required torque value by multiplying the value obtained by the division of the division processing unit 92 by a conversion coefficient 96. The setting unit 72 sets the required rotational speed as the target rotational speed of the operation point. The setting unit 72 sets the required torque value as the target torque value of the operation point.

The map 88 used in the conversion processing unit 90 is stored in advance in the storage unit 56 provided in the management ECU 44. The map 88 associates the electric power with the rotational speed. The conversion coefficients 96 used in the multiplication processing unit 94 are also stored in the storage unit 56 in advance. The conversion coefficient 96 is a coefficient for converting the value obtained by the division processing unit 92 into a torque value.

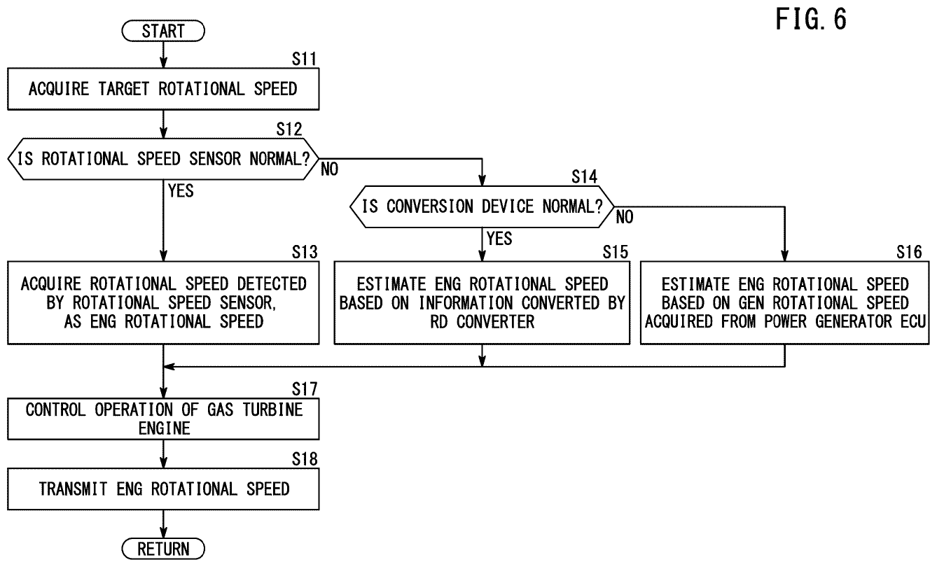

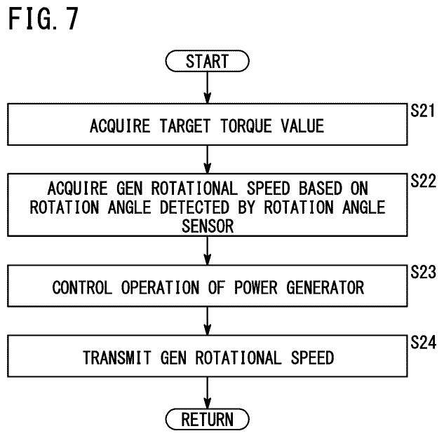

In step S3, the setting unit 72 transmits the target rotational speed to the engine ECU 46. As will be described with reference to FIG. 6, the engine ECU 46 (control unit 82) controls the operation of the gas turbine engine 30 based on the target rotational speed transmitted from the setting unit 72. Further, the setting unit 72 transmits the target torque value to the power generator ECU 48. As will be described with reference to FIG. 7, the power generator ECU 48 (control unit 86) controls the operation of the power generator 34 based on the target torque value transmitted from the setting unit 72.

In step S4, the acquisition unit 70 acquires the ENG rotational speed transmitted from the engine ECU 46. The ENG rotational speed acquired here is the rotational speed of the gas turbine engine 30 recognized by the engine ECU 46. Further, the acquisition unit 70 acquires the GEN rotational speed transmitted from the power generator ECU 48. The GEN rotational speed acquired here is the rotational speed of the power generator 34 recognized by the power generator ECU 48.

In step S5, the comparison unit 74 provided in the management ECU 44 compares the absolute value of the difference between the ENG rotational speed and the GEN rotational speed (|ENG rotational speed-GEN rotational speed|) with a rotational speed difference threshold. The rotational speed difference threshold is stored in the storage unit 56 in advance. If the absolute value of the difference between the ENG rotational speed and the GEN rotational speed is equal to or greater than the rotational speed difference threshold (step S5: YES), the process proceeds to step S6. The fact that the absolute value of the difference between the ENG rotational speed and the GEN rotational speed is equal to or greater than the rotational speed difference threshold means that the difference between the ENG rotational speed recognized by the engine ECU 46 and the GEN rotational speed recognized by the power generator ECU 48 is large. On the other hand, when the absolute value of the difference between the ENG rotational speed and the GEN rotational speed is less than the rotational speed difference threshold (step S5: NO), the process shown in FIG. 4 is terminated. The fact that the absolute value of the difference between the ENG rotational speed and the GEN rotational speed is less than the rotational speed difference threshold means that the difference between the ENG rotational speed recognized by the engine ECU 46 and the GEN rotational speed recognized by the power generator ECU 48 is small.

When the process proceeds from step S5 to step S6, the setting unit 72 updates the operation point. The setting unit 72 sets the lower one of the ENG rotational speed and the GEN rotational speed as the target rotational speed of the operation point. The setting unit 72 acquires a torque value corresponding to the target rotational speed based on an operation point map (not shown) stored in advance in the storage unit 56. The setting unit 72 sets this torque value as the target torque value. The operation point map associates the rotational speed and the torque value with each other so as to allow the power generation device 24 to be operated most efficiently.

In step S7, the setting unit 72 transmits the target rotational speed to the engine ECU 46, as in step S3. Thus, the engine ECU 46 controls the operation of the gas turbine engine 30 based on the updated target rotational speed. Further, the setting unit 72 transmits the target torque value to the power generator ECU 48, as in step S3. Thus, the power generator ECU 48 controls the operation of the power generator 34 based on the updated target torque value.

### Process performed by Engine ECU 46

FIG. 6 is a flowchart of the processing performed by the engine ECU 46. The engine ECU 46 performs processing related to control of the gas turbine engine 30. The engine ECU 46 repeatedly executes a series of steps shown in FIG. 6 while the power of the moving object 10 is in an ON state.

In step S11, the acquisition unit 76 provided in the engine ECU 46 acquires the target rotational speed set by the management ECU 44. Here, the acquisition unit 76 acquires the latest target rotational speed among the target rotational speeds transmitted in step S3 or step S7 shown in FIG. 4.

In step S12, the normality determination unit 78 provided in the engine ECU 46 determines whether the rotational speed sensor 40 is normal or abnormal. For example, the normality determination unit 78 determines that the rotational speed sensor 40 is not normal when the digital signal is not transmitted from the rotational speed sensor 40 even though the gas turbine engine 30 is operating. The normality determination unit 78 determines that the rotational speed sensor 40 is not normal when the rotational speed indicated by the digital signal is not within a predetermined normal range. When the rotational speed sensor 40 is normal in all of these determinations (step S12: YES), the process proceeds to step S13. On the other hand, when the rotational speed sensor 40 is not normal in any one of these determinations, the normality determination unit 78 determines that the rotational speed sensor 40 is abnormal. In this case (step S12: NO), the process proceeds to step S14.

When the process proceeds from step S12 to step S13, the acquisition unit 76 acquires the rotational speed detected by the rotational speed sensor 40 as the ENG rotational speed. Thus, the engine ECU 46 recognizes the ENG rotational speed.

When the process proceeds from step S12 to step S14, the normality determination unit 78 determines whether the conversion device 50 is normal or abnormal. Here, the normality determination unit 78 can perform the determination by the same method as that in step S12. If the conversion device 50 is normal in all of these determinations (step S14: YES), the process proceeds to step S15. On the other hand, when the conversion device 50 is not normal in any one of these determinations, the normality determination unit 78 determines that the conversion device 50 has an abnormality. In this case (step S14: NO), the process proceeds to step S16.

When the process proceeds from step S14 to step S15, the estimation unit 80 provided in the engine ECU 46 estimates the ENG rotational speed based on the information converted by the conversion device 50. Specifically, the estimation unit 80 converts the rotation angle converted into a digital signal by the conversion device 50, into the rotational speed. The estimation unit 80 sets the rotational speed obtained by the conversion, as the ENG rotational speed. Thus, the engine ECU 46 recognizes the ENG rotational speed.

When the process proceeds from step S14 to step S16, the estimation unit 80 estimates the ENG rotational speed based on the GEN rotational speed acquired from the power generator ECU 48. Specifically, the estimation unit 80 sets the GEN rotational speed as the ENG rotational speed. Thus, the engine ECU 46 recognizes the ENG rotational speed.

When the process proceeds from one of step S13, step S15, and step S16 to step S17, the control unit 82 provided in the engine ECU 46 controls the operation of the gas turbine engine 30 such that the rotational speed of the gas turbine engine 30 becomes the target rotational speed. For example, the control unit 82 controls the fuel injection device 32 such that the rotational speed of the gas turbine engine 30 becomes the target rotational speed by using the ENG rotational speed recognized at that time.

In step S18, the control unit 82 transmits the ENG rotational speed recognized at that time, to the management ECU 44. The ENG rotational speed transmitted at this time point is used in the determination process of step S5 in FIG. 4.

### Processing performed by Power generator ECU 48

FIG. 7 is a flowchart of the processing performed by the power generator ECU 48. The power generator ECU 48 performs processing related to control of the power generator 34. The power generator ECU 48 repeatedly executes a series of steps shown in FIG. 7 while the power of the moving object 10 is in an ON state.

In step S21, the acquisition unit 84 provided in the power generator ECU 48 acquires the target torque value set by the management ECU 44. Here, the acquisition unit 84 acquires the latest target torque value among the target torque values transmitted in step S3 or step S7 shown in FIG. 4.

In step S22, the acquisition unit 84 acquires the GEN rotational speed based on the rotation angle detected by the rotation angle sensor 42. For example, the acquisition unit 84 converts the rotation angle detected by the rotation angle sensor 42 into the rotational speed, and sets the rotational speed obtained by the conversion, as the GEN rotational speed. Thus, the power generator ECU 48 recognizes the GEN rotational speed.

In step S23, the control unit 86 provided in the power generator ECU 48 controls the operation of the power generator 34 such that the torque value of the power generator 34 becomes the target torque value. For example, the control unit 86 controls the AC-DC converter 38, using the torque value corresponding to the GEN rotational speed recognized at that time and the target torque value, such that the torque value of the power generator 34 becomes the target torque value.

In step S24, the control unit 86 transmits the GEN rotational speed recognized at that time, to the management ECU 44. The GEN rotational speed transmitted at this time point is used in the determination process of step S5 in FIG. 4.

### Operation and Effect of Power Generation System 22

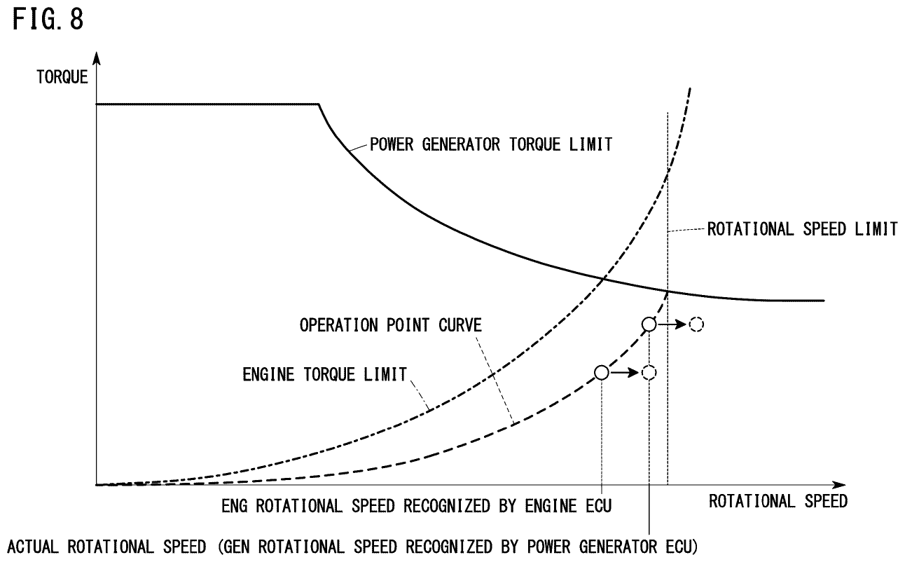

FIGS. 8 to 10 are diagrams showing the relationship between the rotational speed and the torque of the power generation device 24. The power generation system 22 achieves unique advantageous effects by performing the processing of steps S4 to S7 of FIG. 4. In order to describe the advantageous effects of the power generation system 22, first, control in a case where the processing of steps S4 to S7 of FIG. 4 is not performed will be described.

The operation control of the gas turbine engine 30 in the case where the processing of steps S4 to S7 of FIG. 4 is not performed will be described with reference to FIG. 8. The engine ECU 46 recognizes, for example, the rotational speed detected by the rotational speed sensor 40, as the ENG rotational speed. The engine ECU 46 controls the operation of the gas turbine engine 30 based on the recognized ENG rotational speed such that the ENG rotational speed becomes the target rotational speed.

There are cases in which the ENG rotational speed detected by the rotational speed sensor 40 may differ from the actual rotational speed of the gas turbine engine 30 due to a failure of the rotational speed sensor 40, noise, or the like. For example, there is a case where the ENG rotational speed detected by the rotational speed sensor 40 may be lower than the actual rotational speed of the gas turbine engine 30. In this case, as shown in FIG. 8, the ENG rotational speed recognized by the engine ECU 46 is lower than the actual rotational speed of the gas turbine engine 30. In addition, the ENG rotational speed recognized by the engine ECU 46 is lower than the GEN rotational speed recognized by the power generator ECU 48. In this case, the engine ECU 46 increases the rotational speed of the gas turbine engine 30. As a result, the gas turbine engine 30 may be over-rotated, and there is a risk that the actual rotational speed may exceed the limit of the rotational speed (rotational speed limit).

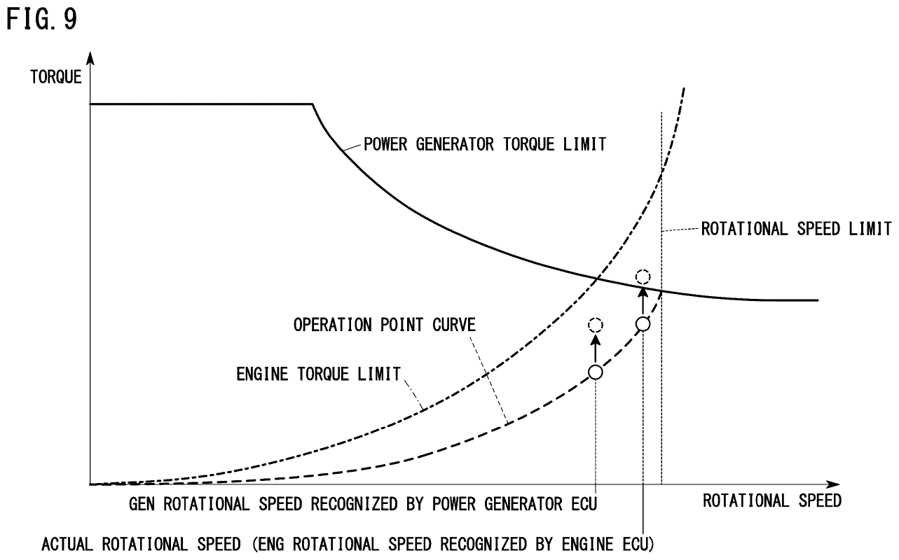

The operation control of the power generator 34 in the case where the processing of steps S4 to S7 of FIG. 4 is not performed will be described with reference to FIG. 9. The power generator ECU 48 converts the rotation angle detected by the rotation angle sensor 42 into a rotational speed, and recognizes this rotational speed as the GEN rotational speed. The power generator ECU 48 controls the operation of the power generator 34 based on the torque value corresponding to the recognized GEN rotational speed such that the recognized torque value becomes the target torque value.

The rotation angle sensor 42, which transmits an analog signal, is less likely to fail than the rotational speed sensor 40, which transmits a digital signal. Therefore, the reliability of the rotation angle sensor 42 is higher than the reliability of the rotational speed sensor 40. However, even the rotation angle sensor 42 may also fail or generate noise. For example, there is a case where the GEN rotational speed detected by the rotation angle sensor 42 may be lower than the actual rotational speed of the power generator 34. In this case, as shown in FIG. 9, the GEN rotational speed recognized by the power generator ECU 48 is lower than the actual rotational speed of the power generator 34. The GEN rotational speed recognized by the power generator ECU 48 is lower than the ENG rotational speed recognized by the engine ECU 46. In this case, the power generator ECU 48 increases the torque value of the power generator 34. As a result, over-torque may occur in the power generator 34, and there is a risk that the actual torque value may exceed the limit (power generator torque limit).

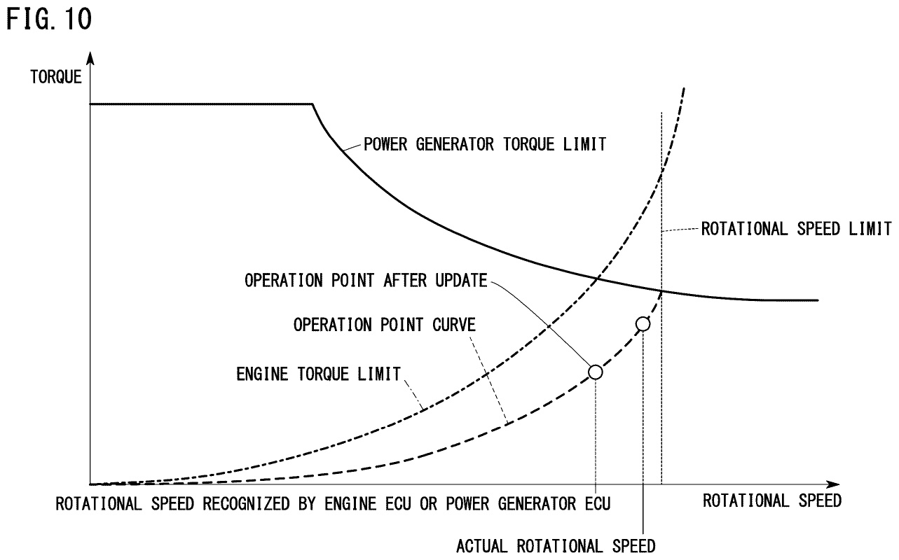

The unique advantageous effects of the power generation system 22 when the processing of steps S4 to S7 of FIG. 4 is performed will be described with reference to FIG. 10. In step S5, the comparison unit 74 provided in the management ECU 44 determines whether or not the absolute value of the difference between the ENG rotational speed recognized by the engine ECU 46 and the GEN rotational speed recognized by the power generator ECU 48 is equal to or greater than the rotational speed difference threshold. When the difference between the ENG rotational speed and the GEN rotational speed is equal to or larger than the rotational speed difference threshold, the setting unit 72 provided in the management ECU 44 sets the lower one of the ENG rotational speed and the GEN rotational speed, as the target rotational speed of the updated operation point (i.e., the operation point after the update). Further, the setting unit 72 acquires a torque value corresponding to the target rotational speed, and sets the torque value as the target torque value of the updated operation point.

According to the power generation system 22, the situation described with reference to FIG. 8 can be prevented. That is, according to the power generation system 22, even when the difference between the ENG rotational speed and the actual rotational speed (GEN rotational speed) becomes large, it is possible to prevent the gas turbine engine 30 from being over-rotated. Further, according to the power generation system 22, it is possible to prevent the situation described with reference to FIG. 9. That is, according to the power generation system 22, even when the difference between the GEN rotational speed and the actual rotational speed (ENG rotational speed) becomes large, it is possible to prevent over-torque of the power generator 34.

According to the power generation system 22, the operation point is updated when the difference between the ENG rotational speed and the GEN rotational speed is equal to or greater than the rotational speed difference threshold. This can prevent excessive restriction on the control of the gas turbine engine 30 and the control of the power generator 34.

In the power generation system 22, the estimation unit 80 provided in the engine ECU 46 estimates the ENG rotational speed in preparation for the case where a malfunction occurs in the rotational speed sensor 40. According to the power generation system 22, redundancy can be improved.

### Supplementary Notes

In addition to the above disclosure, the following Supplementary Notes are further disclosed.

### Supplementary Note 1

The control device (28) includes: the first rotational speed acquisition unit (76) configured to acquire the first rotational speed, which is the rotational speed of the gas turbine engine (30), based on a signal supplied from the rotational speed sensor (40) provided in the gas turbine engine; the second rotational speed acquisition unit (84) configured to acquire the second rotational speed, which is the rotational speed of the power generator (34), based on a signal supplied from the rotation angle sensor (42) provided in the power generator, the power generator being rotated by the gas turbine engine; the comparison unit (74) configured to compare the first rotational speed with the second rotational speed; and the control unit (82, 86) configured to control the gas turbine engine and the power generator based on the lower one of the first rotational speed and the second rotational speed based on the comparison result by the comparison unit.

According to the above configuration, even when the difference between the ENG rotational speed and the actual rotational speed (GEN rotational speed) becomes large, it is possible to prevent the gas turbine engine from being over-rotated. Further, according to the above configuration, even when the difference between the GEN rotational speed and the actual rotational speed (ENG rotational speed) becomes large, it is possible to prevent over-torque of the power generator. As a result, according to the above configuration, it is possible to provide a control device capable of controlling the power generation system more favorably.

### Supplementary Note 2

In the control device according to Supplementary Note 1, in a case where the difference between the first rotational speed and the second rotational speed is equal to or greater than the rotational speed difference threshold, the control unit may control the gas turbine engine and the power generator based on the lower one of the first rotational speed and the second rotational speed.

The above configuration can prevent excessive limitation on the control of the gas turbine engine and the control of the power generator. As a result, according to the above configuration, it is possible to provide a control device capable of controlling the power generation system more favorably.

### Supplementary Note 3

In the control device according to Supplementary Note 2, the control unit may control the gas turbine engine so as to achieve a target rotational speed acquired based on a required electric power, and controls the power generator so as to achieve a target torque value acquired based on the required electric power.

### Supplementary Note 4

The control device according to any one of Supplementary Notes 1 to 3 may further include the estimation unit (80) configured to estimate the first rotational speed based on the signal supplied from the rotation angle sensor in a case where an abnormality occurs in the rotational speed sensor.

According to the above configuration, redundancy can be improved.

### Supplementary Note 5

In the control device according to Supplementary Note 1, the control unit may control the gas turbine engine by setting the lower one of the first rotational speed and the second rotational speed as the target value of the gas turbine engine, and control the power generator by setting a torque value corresponding to the lower one of the first rotational speed and the second rotational speed as the target torque value of the power generator.

### Supplementary Note 6

The moving object (10) includes the control device according to any one of Supplementary Notes 1 to 5.

### Supplementary Note 7

The control method includes: acquiring the first rotational speed, which is the rotational speed of the gas turbine engine, based on a signal supplied from the rotational speed sensor provided in the gas turbine engine; acquiring the second rotational speed, which is the rotational speed of the power generator, based on a signal supplied from the rotation angle sensor provided in the power generator rotated by the gas turbine engine; comparing the first rotational speed with the second rotational speed; and controlling the gas turbine engine and the power generator based on the lower one of the first rotational speed and the second rotational speed based on the result of comparison between the first rotational speed and the second rotational speed.

According to the above configuration, even when the difference between the ENG rotational speed and the actual rotational speed (GEN rotational speed) becomes large, it is possible to prevent the gas turbine engine from being over-rotated. Further, according to the above configuration, even when the difference between the GEN rotational speed and the actual rotational speed (ENG rotational speed) becomes large, it is possible to prevent over-torque of the power generator. Therefore, according to the above configuration, it is possible to provide a control method capable of controlling the power generation system more favorably.

Moreover, it should be noted that the present invention is not limited to the disclosure described above, but various configurations may be adopted therein without departing from the essence and gist of the present invention.

1. A control device comprising:
one or more processors that execute computer-executable instructions stored in a memory, wherein the one or more processors execute the computer-executable instructions to cause the control device to:
acquire a first rotational speed, which is a rotational speed of a gas turbine engine, based on a signal supplied from a rotational speed sensor provided in the gas turbine engine;
acquire a second rotational speed, which is a rotational speed of a power generator, based on a signal supplied from a rotation angle sensor provided in the power generator, the power generator being rotated by the gas turbine engine;
compare the first rotational speed that has been acquired, with the second rotational speed that has been acquired; and
control the gas turbine engine and the power generator based on a lower one of the first rotational speed and the second rotational speed based on a result of comparison between the first rotational speed and the second rotational speed.

2. The control device according to claim 1, wherein in a case where a difference between the first rotational speed and the second rotational speed is equal to or greater than a rotational speed difference threshold, the one or more processors cause the control device to control the gas turbine engine and the power generator based on the lower one of the first rotational speed and the second rotational speed.

3. The control device according to claim 2, wherein the one or more processors cause the control device to:
control the gas turbine engine so as to achieve a target rotational speed acquired based on a required electric power; and control the power generator so as to achieve a target torque value acquired based on the required electric power.

4. The control device according to claim 1, wherein the one or more processors cause the control device to estimate the first rotational speed based on the signal supplied from the rotation angle sensor in a case where an abnormality occurs in the rotational speed sensor.

5. The control device according to claim 1, wherein the one or more processors cause the control device to:
control the gas turbine engine by setting the lower one of the first rotational speed and the second rotational speed as a target value of the gas turbine engine; and control the power generator by setting a torque value corresponding to the lower one of the first rotational speed and the second rotational speed as a target torque value of the power generator.

6. A moving object comprising the control device according to claim 1.

7. A control method comprising:
acquiring a first rotational speed, which is a rotational speed of a gas turbine engine, based on a signal supplied from a rotational speed sensor provided in the gas turbine engine;
acquiring a second rotational speed, which is a rotational speed of a power generator, based on a signal supplied from a rotation angle sensor provided in the power generator, the power generator being rotated by the gas turbine engine;
comparing the first rotational speed with the second rotational speed; and
controlling the gas turbine engine and the power generator based on a lower one of the first rotational speed and the second rotational speed based on a result of comparison between the first rotational speed and the second rotational speed.
